(19) United States
(12) Patent Application Publication
(10) Pub. No.: US 2009/0130307 A1
(43) Pub. Date: May 21, 2009

(54) Method for the rapid densification of a porous substrate, comprising the formation of a solid deposit within the porosity of the substrate

(76) Inventors: Alain Guette, Le Bouscat (FR); Rene Pailler, Cestas (FR); Nicolas Eberling-Fux, Talence (FR); Francois Christin, Saint Aubin De Medoc (FR)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/920,200

(22) PCT Filed: May 12, 2006
(86) PCT No.: PCT/FR2006/050437

§ 371 Date: Nov. 9, 2007

(30) Foreign Application Priority Data
May 13, 2005 (FR) 0504813

(51) Int. Cl. B05D 7/22

(52) U.S. Cl. 427/230

(57) ABSTRACT

A refractory porous fiber substrate is densified by forming a solid matrix deposit from a fluid composition containing a reagent fluid that is a precursor for the material of the solid deposit that is to be formed, together with an optional dilution fluid. The operation is performed at a temperature and a pressure that enable the reagent fluid and/or the optionally-present dilution fluid to be maintained in the supercritical state, while spontaneously and directly forming the solid deposit of the matrix, thereby enabling the duration of the process to be reduced considerably compared with conventional CVI methods.

### BACKGROUND OF THE INVENTION

The invention relates to forming solid matrix deposits within the pores of porous substrates by using a fluid composition that contains a fluid that is a precursor for the material of the solid deposit that is to be formed, optionally together with a dilution fluid.

The invention seeks to densify porous substrates by forming deposits in the pores to the core of such a substrate, and not just forming surface covering.

The invention can be used for densifying porous substrates with a solid matrix deposit within the pores of the substrate, in particular for making composite material parts by densifying porous substrates which reinforce the composite material, typically fiber substrates. More particularly, the invention seeks to make thermostructural composite material parts having reinforcement made of refractory fibers (carbon or ceramic fibers) densified by a refractory matrix (carbon or ceramic matrix). Typical thermostructural materials are carbon/carbon (or C/C) composite materials having both fibers and matrix made of carbon, and ceramic matrix composite (or CMC) materials. These materials possess the mechanical properties needed for making structural elements and they have the ability to conserve these properties at high temperatures.

Chemical vapor infiltration (CVI) methods are well known and commonly used for densifying porous substrates with a solid material. The substrates for densification are placed in an oven into which a reaction gas is admitted, under determined temperature and pressure conditions so as to form the desired solid deposit directly by decomposition of the reaction gas or by reaction between several of its constituent gases.

CVI methods, in particular for forming a carbon or a ceramic matrix, are commonly implemented at a temperature of about 900° C. to 1100° C. and under low pressure, less than 100 kilopascals (kPa), typically lying in the range 1 kPa to 50 kPa. A low pressure is recommended in order to encourage the gas to diffuse into the cores of the substrates and avoid the surface pores thereof becoming closed off too quickly, since that would prevent densification continuing within the cores of the substrates, and would lead to a strong densification gradient within the substrates.

In order to densify porous substrates, it is also known to use densification methods relying on a liquid technique that consists in impregnating the substrates with a liquid composition containing a precursor for the material of the matrix that is to be formed, and then in transforming the precursor. The precursor is typically a resin or a tar that is used directly or in solution in a solvent for the purpose of impregnating the substrates. After drying (eliminating the solvent) and cross-linking the resin, the solid deposit of the matrix is obtained by applying pyrolytic heat treatment to the resin.

Known methods of densification using a gas or a liquid technique are generally lengthy or very lengthy, and consequently they are expensive. Densifying substrates by CVI can require several tens or even several hundreds of hours, while densification by a liquid technique requires repeated impregnation, drying, cross-linking, and pyrolysis cycles.

The use of a fluid in the supercritical state in a process for densifying a porous substrate is described in the prior art. U.S. Pat. No. 4,552,786 discloses a method of densifying a porous ceramic substrate comprising dissolving a precursor for the ceramic in a fluid (propane) which is taken to the supercritical state so as to penetrate together with the precursor into the pores of the substrate, followed by releasing the liquid precursor within said pores by returning to non-supercritical conditions, where such a return is accompanied by a drop in the dilution power of the propane. The transformation of the liquid precursor into a ceramic is then performed by heat treatment. That thus constitutes a densification process using a liquid technique, the fluid in the supercritical state being used only for causing the liquid precursor to penetrate into the porous substrate.

Document CN 1377855A discloses a similar method in which solid fillers (of carbon or of silicon carbide) are added to the liquid precursor of the ceramic in order to reduce the time taken to densify the substrate.

U.S. Pat. Nos. 5,780,027 and 6,689,700 describe methods of forming solid deposits on a surface by dissolving a precursor for the material that is to be deposited in a solvent in the supercritical state, by exposing the substrate to said solution under conditions in which the precursor is in a stable state, and by introducing into the solution a reaction agent for triggering a chemical reaction involving the precursor and causing material to be deposited on the surface of the substrate. The intended application is depositing metal, metal oxide, or semiconductor films on substrates. A process of that type is also envisaged in U.S. Pat. No. 5,789,027 for depositing a material in a microporous or nanoporous substrate, but no precise description is given of an implementation. It should be observed that the substrate is maintained at a temperature that is relatively low, about 200° C., which might be sufficient to ensure polymerization, but which is too low to enable ceramic or carbon to be formed.

Neither of the latter two documents envisages densifying a fiber type porous substrate to the core, i.e. a substrate that is macroporous (i.e. having pores of a size in the range a few tens of micrometers to a few hundreds of micrometers). Depositing a material in a substrate that is microporous (pore sizes of micrometer order) or nanoporous (pore sizes of a few nanometers to a few hundreds of nanometers) takes place to a limited depth only, close to the surface. In this context, it should be observed that U.S. Pat. No. 6,689,700 describes using photolysis, which can occur only at the surface.

In addition, that known method imposes conditions in which the precursor remains stable until the deposition reaction is initiated by delivering a reaction agent, i.e. it imposes a limit on substrate temperature of no more than 250° C. or perhaps 300° C.

Furthermore, provision must be made for separately introducing a reaction agent.

### OBJECT AND SUMMARY OF THE INVENTION

An object of the invention is to provide a method enabling a solid matrix deposit to be infiltrated to the core and in accelerated manner within the pores of a refractory substrate.

This object is achieved by a method of densifying a refractory porous fiber substrate by forming a solid deposit of refractory matrix within the pores of the substrate from a fluid composition that is diffused within the substrate and that contains at least a reagent fluid that is a precursor for the material constituting the solid deposit of the matrix that is to be formed, optionally together with a dilution fluid, the method being implemented at a temperature and a pressure that make it possible i) to maintain the reagent fluid and/or the optionally-present dilution fluid in the supercritical state, and ii) to form the solid deposit of the refractory matrix spontaneously and directly within the substrate from the precursor reagent fluid.

The term “refractory porous fiber substrate” is used to mean a substrate made up of carbon or ceramic fibers, and the term “refractory matrix” is used to mean a matrix of carbon and/or ceramic.

Typically, the solid deposit of the matrix is formed with the porous substrate at a temperature greater than 600° C., preferably lying in the range 600° C. to 1500° C. The pressure is greater than the pressure PC of the critical point of the dilution fluid and/or of the precursor fluid.

As shown below, the formation of a solid matrix deposit by supercritical chemical infiltration is considerably faster than with known processes of the CVI type. In addition, and in particularly surprising manner, it is effective at pressures that are much higher than the pressures presently in use for known methods of the CVI type.

In particular, with a precursor fluid that is reactive to a very small extent only, the presence of a dilution fluid can be unnecessary. If it is necessary, the fluid composition may comprise at least one reagent fluid that is a precursor for the material of the solid deposit of the matrix that is to be formed together with a dilution fluid so as to obtain the desired solid matrix deposit, while avoiding a phenomenon of uniform phase nucleation causing powder to form in the supercritical phase.

The initial molar ratio of the dilution fluid in the composition may be selected to be relatively high, for example up to 90% or even more.

The dilution fluid may be a fluid that is chemically inert relative to forming the solid deposit, e.g. it may be selected from the rare gases of the atmosphere, or it may be a fluid that reacts in the formation of the solid deposit, for example it may be selected from nitrogen and carbon dioxide.

Like the dilution gas, the reagent gas may be in the supercritical state during deposition or infiltration.

The supercritical chemical infiltration method of the invention may be performed in a closed enclosure or it may be performed with the fluid composition flowing continuously.

With a closed enclosure, the method comprises the steps of introducing a quantity of fluid composition into an enclosure containing the substrate, and of establishing, within the enclosure, temperature and pressure conditions that enable the solid deposit of the matrix to be formed directly and spontaneously, while maintaining the reagent fluid and/or the optionally present dilution fluid in the supercritical state.

With a continuous flow, the method comprises the steps of continuously admitting a stream of fluid composition into an enclosure containing the substrate, of continuously extracting a stream of effluent fluid from the enclosure, and of maintaining substrate temperature and pressure conditions within the enclosure that enable the solid matrix deposit to form directly and spontaneously, while maintaining the reagent fluid and/or the optionally-present dilution fluid in the supercritical state.

### BRIEF DESCRIPTION OF THE DRAWINGS

Other features and advantages of the invention appear on reading the following description given by way of non-limiting indication and with reference to the accompanying drawings, in which:

FIG. 1 is a highly diagrammatic view of an installation enabling a supercritical chemical infiltration method of the invention to be implemented with a temperature gradient;

FIGS. 2 and 3 are highly diagrammatic views showing variants of the FIG. 1 installation;

FIG. 4 is a highly diagrammatic view of an installation enabling a supercritical chemical infiltration method in accordance with the invention to be implemented under conditions that are isothermal or quasi-isothermal;

FIG. 5 is a highly diagrammatic view of a variant of the FIG. 4 installation; and

FIGS. 6 to 16 are micrographs showing solid deposits of matrix obtained by supercritical chemical infiltration methods in accordance with the invention.

### DETAILED DESCRIPTION OF IMPLEMENTATIONS OF THE INVENTION

As is well known, a fluid is in the supercritical state when its temperature and its pressure are greater than those of the critical point for the fluid in question. The density of the fluid in the supercritical state is comparable to its density in the liquid phase, but its behavior, in terms of viscosity and diffusivity, comes to close to that of the gas phase. In addition, in the supercritical state, dissolving power is greatly increased.

Fundamentally, the supercritical chemical infiltration method in accordance with the invention consists in putting a porous substrate for densification by means of a solid deposit in the presence of a fluid composition comprising a fluid that is a precursor for the deposit that is to be performed, optionally together with a dilution fluid or a fluid for dissolving the precursor fluid, under conditions of pressure and temperature that are such that the reagent fluid and/or the optionally-present dilution fluid is/are in the supercritical state, and such that the chemical reaction forming the solid deposit occurs spontaneously.

The presence of the dilution fluid makes it possible, in the supercritical phase, to avoid homogenous phase nucleation phenomena that would cause powder to be formed instead of a desired continuous deposit. Nevertheless, when the reagent fluid is only slightly reactive, it can itself perform the dilution function such that it can be unnecessary to add any dilution fluid.

When present, the dilution fluid may be a fluid that is chemically inert relative to the reaction forming the solid deposit, i.e. that is not involved in that chemical reaction. It is possible to use a rare gas as found in air, e.g. argon.

The dilution fluid may also be a reagent fluid, i.e. it may participate in the chemical reaction forming the deposit. It is possible to use nitrogen (which can give rise to redox reactions) and/or carbon dioxide.

The precursor fluid is selected as a function of the nature of the refractory matrix that is to be formed. It is possible to select the precursors that are commonly used in conventional CVI methods, e.g. hydrocarbons that are precursors for carbon when forming a carbon matrix, or compounds that are precursors for boron and/or silicon when forming a ceramic matrix.

Depending on the characteristics of the critical point of the precursor fluid, the fluid may optionally be in the supercritical state at the same time as the dilution fluid.

The dilution ratio of the precursor fluid is selected to be quite high in order to avoid the above-mentioned phenomena of homogeneous phase nucleation and premature closure of access to the pores in the core of the substrate. Thus, the initial molar ratio of the dilution fluid in the fluid composition may be selected to have a value of as much as 90%, or even more.

The pressure and the temperature for forming the solid deposit of the matrix are selected as a function of the pressure (P_{c}) and the temperature (T_{c}) of the critical point of the dilution fluid and/or of the critical point of the precursor fluid (in particular when the precursor fluid is used pure, without any dilution fluid), with it being necessary also to select the temperature to have a value that is sufficiently high to enable the deposition chemical reaction to take place spontaneously from the precursor fluid.

The supercritical chemical infiltration method is implemented on a refractory porous fiber substrate, i.e. a substrate made up of refractory fibers, made of carbon or of ceramic. The substrate may be shaped so as to constitute a fiber preform of shape close to that of a composite material part that is to be made. The substrate may be consolidated prior to supercritical chemical infiltration. Consolidation consists in limited partial densification of the substrate, sufficient to bond the fibers together so that the substrate can be handled while conserving its shape without requiring any supporting tooling. Consolidation by partial densification may be performed in known manner by using a liquid technique.

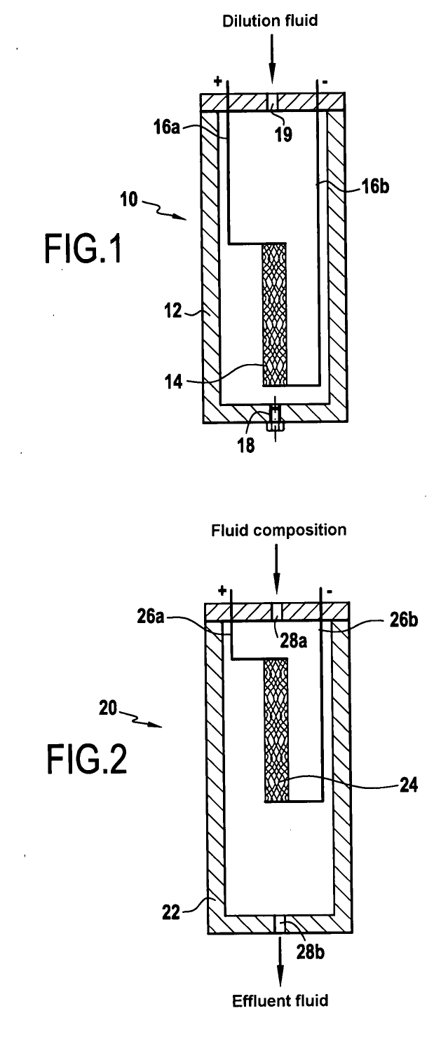

The supercritical chemical infiltration method may be implemented in batch mode with a temperature gradient by using a reactor 10 of the kind shown diagrammatically in FIG. 1.

The inside volume of the reactor 10 is defined by an enclosure 12, e.g. made of a metal material, such as a nickel-based superalloy of the “Inconel” type. With a porous fiber substrate 14 that is electrically conductive, e.g. a substrate made of carbon or graphite fibers, or of fibers coated in carbon or graphite, the substrate can be heated by the Joule effect. The substrate 14 is electrically connected to an external electrical power supply circuit (not shown) via electrodes 16a, 16b that pass through the cover of the reactor.

The precursor fluid, which may be in the liquid state, is introduced into the reactor via its base through an access 18. The access is closed and the reactor is brought to pressure by introducing the dilution fluid through an opening 19, e.g. formed in the reactor cover, while the substrate is being heated. In the absence of a dilution fluid, it is possible to introduce the precursor fluid via one of the openings and to raise it to the desired pressure.

Because of the cooling by radiation and convection that takes place at the exposed surfaces of the substrate 14, a temperature gradient is established between a hotter portion of the core of the substrate, and portions of the substrate that are closer to its outside surface. Densification of the substrate is thus initially encouraged in the core and progresses towards the outside surface, as is well known for temperature gradient chemical infiltration methods.

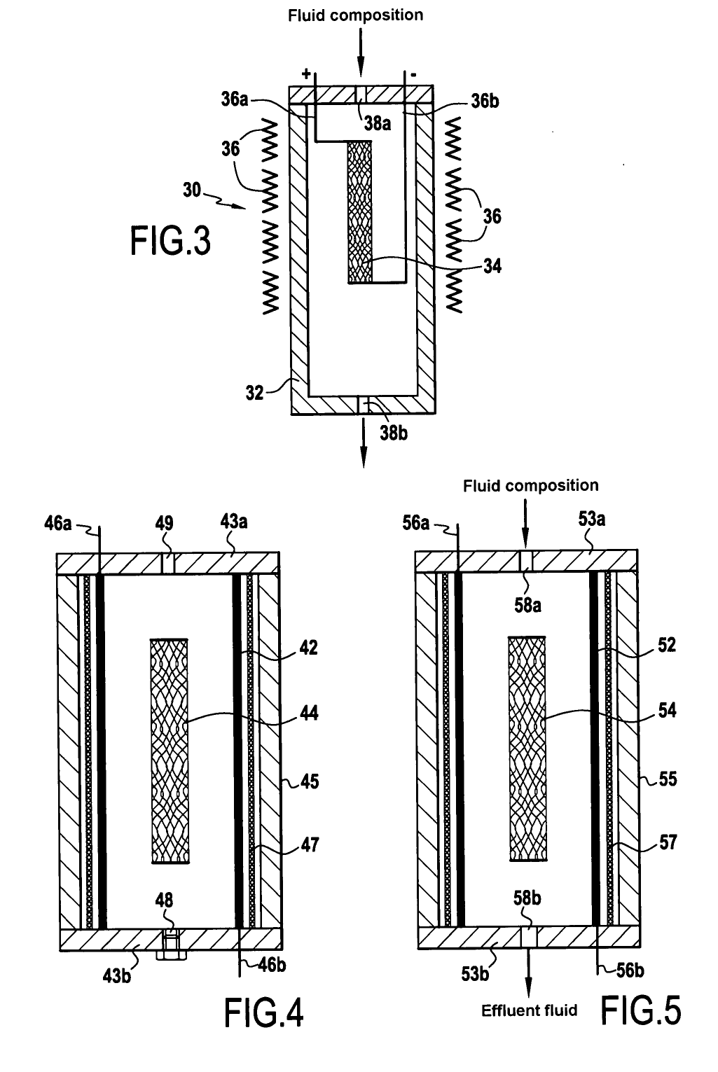

In a variant, the method can be implemented in a continuous mode by means of a reactor 20 of the kind shown diagrammatically in FIG. 2.

The inside volume of the reactor 20 is defined by walls 22, e.g. made of “Inconel”. When a porous fiber substrate 24 is electrically conductive, the substrate can be heated by the Joule effect by connecting the substrate to an electrical power supply circuit (not shown) by means of electrodes 26a, 26b passing through the cover of the reactor.

The reactor 20 has an inlet opening 28a formed through its cover to admit into the reactor the composition containing the precursor fluid and any dilution fluid, and an outlet opening 28b formed in the base of the reactor for extracting an effluent fluid, with the composition flowing through the reactor while maintaining it at the desired pressure.

FIG. 3 is a diagram of a reactor 30 that also enables the method to be implemented in continuous mode, and that differs from the reactor 20 in that electrical heater resistors 36 are disposed on the outside of the reactor 30 close to the walls 32 thereof. With a porous fiber substrate 34 that conducts electricity, the substrate may be heated at least in part by the Joule effect by connecting the substrate to an electrical power supply circuit (not shown) via electrodes 36a, 36b passing through the cover of the reactor.

The reactor 30 has an inlet opening 38a formed in its cover and an outlet opening 38b formed in its base to enable flow to be continuous, with the composition containing the precursor fluid and any dilution fluid being admitted and with an effluent fluid being extracted.

The electrical resistors 36 are distributed over the height of the reactor. They may be powered separately with electricity so as to control temperature gradients between the walls of the reactor 20 and the substrate 24, and thus control convection movements of the fluid composition introduced into the reactor so as to minimize temperature non-uniformities within the composition inside the reactor.

In a variant, the direct heating of the electrically conductive substrate in the embodiments of FIGS. 1 to 3 could be performed not by the Joule effect by connection to an electrical power supply, but by inductive coupling with an induction coil. The coil then surrounds the substrate, preferably with a thermally insulating screen being interposed between them, and the assembly being housed in a metal casing, e.g. made of “Inconel” capable of withstanding the pressure needed by the supercritical phase. A plurality of substrates may be densified simultaneously, for example the substrate(s) could be supported by one or more non-conductive trays.

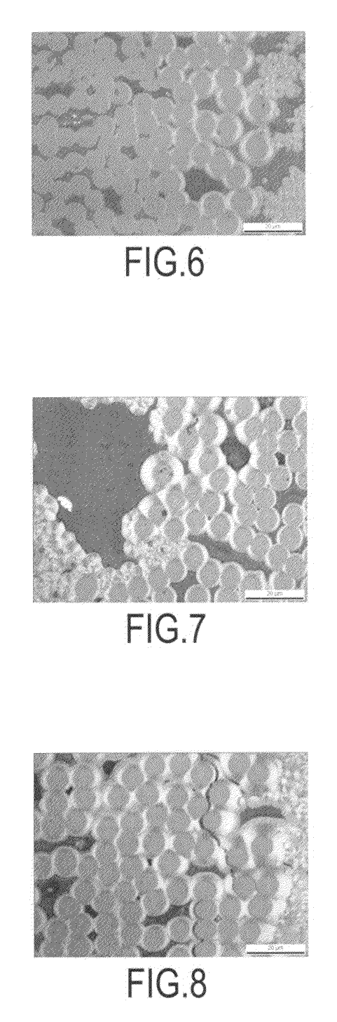

FIG. 4 shows a reactor 40 enabling a method of the invention to be implemented in batch mode with uniform or quasi-uniform heating of the substrate, i.e. under isothermal or quasi-isothermal conditions, or in the absence or quasi-absence of any temperature gradient within the substrate.

The reactor proper 40 is defined by a side wall 42 of electrically conductive material, e.g. of graphite, surrounding the porous fiber substrate 44, and by a cover 43a and a base 43b. The wall 42 is heated, e.g. by the Joule effect, by connecting the ends of the wall 42 to an electrical power supply via electrodes 46a, 46b passing through the cover 43a and through the base 43b, enabling the volume of the reactor 40 and of the substrate 44 to be heated. Thermal insulation 47 is interposed between the wall 42 and the wall 45.

A metal casing 45, e.g. made of “Inconel”, that is capable of withstanding the pressure needed by the supercritical phase, surrounds the wall 42 and is connected to the cover 43a and to the base 43b, which may be made of the same material as the casing 45.

An opening 48 is formed through the base 43b to enable the precursor fluid to be introduced into the reactor, which fluid may be in the liquid state. After closing the opening 48, the reactor can be put under pressure by introducing dilution fluid through an opening 49 formed in the cover 43b. In the absence of dilution fluid, the precursor fluid can be introduced through the opening 48 and then raised to the desired pressure.

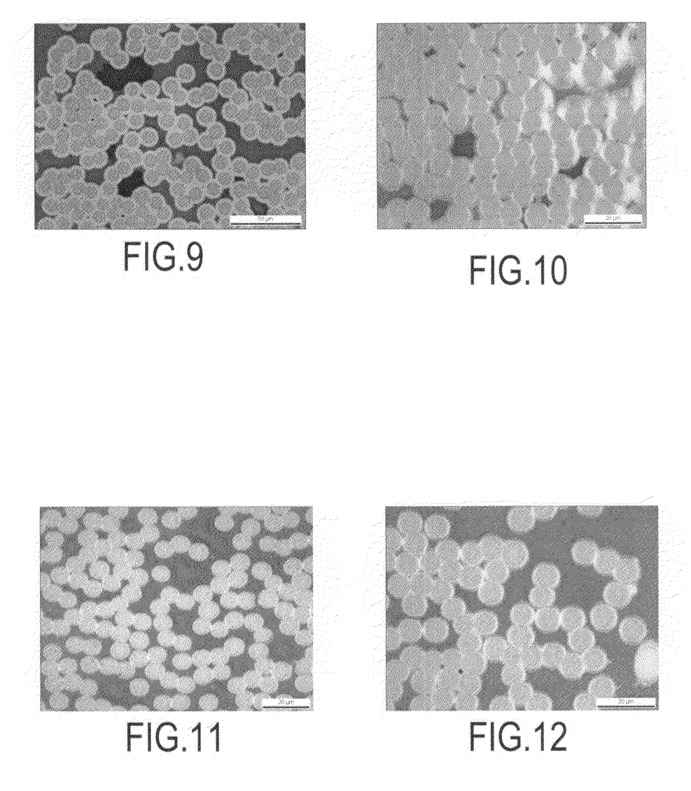

FIG. 5 shows a reactor 50 enabling a method of the invention to be implemented in continuous mode under conditions that are isothermal or quasi-isothermal.

The inside volume of the reactor 50 is defined by a side wall 52 of electrically conductive material, e.g. of graphite, surrounding a porous fiber substrate 54 for densifying. The reactor 50 is closed by a cover 53a and by a base 53b at its top and bottom ends. The wall 52 is heated by the Joule effect by being connected to an electrical power supply (not shown) by means of electrodes 56a, 56b passing through the cover 53a and the base 53b, respectively, enabling the volume of the reactor 50 and of the substrate 54 to be heated. Thermal insulation 57 is interposed between the wall 52 and the wall 55.

A metal casing 55, e.g. made of “Inconel”, that is capable of withstanding the pressure needed for the supercritical phase, surrounds the wall 52 and is connected to the cover 53a and to the base 53b which may be made of the same material as the casing 55.

An inlet opening 58a is formed through the cover 53a to admit into the reactor the composition containing the precursor fluid and any dilution fluid, and an outlet opening 58b is formed through the base 53b of the reactor for extracting an effluent fluid, the composition being caused to flow continuously through the reactor while maintaining it at the desired pressure.

In the embodiments of FIGS. 4 and 5 the substrate may be supported by being suspended from the cover of the reactor. It is also possible to place the substrate on a tray, and to densify a plurality of substrates supported by one or more trays, simultaneously.

In a variant, in the embodiments of FIGS. 4 and 5, it is possible to use a reactor having a side wall that forms a susceptor that is heated by being coupled inductively with an induction coil that surrounds it. The wall of the reactor may be made of graphite, for example. The assembly comprising the susceptor and the induction coil is then housed in a metal casing, e.g. made of “Inconel”, capable of withstanding the pressure needed for the supercritical phase. The induction coil may be made up of a plurality of segments that are controlled individually in order to control temperature gradients within the reactor.

Naturally, the various heating techniques described above (direct resistive heating, external resistive heating, and inductive heating) can be used on their own or in combination, whether for a reactor that is operating in continuous mode or for a reactor that is operating in batch mode, and regardless of whether the method is a temperature gradient method or an isothermal method.

### EXAMPLE 1

A laboratory reactor of the kind shown in FIG. 1, having a volume of 0.5 liters (L) was used for densifying a porous substrate with a matrix, the substrate being made up of a fiber preform of carbon fibers. The preform was made up of superposed fiber layers bonded together by three-dimensional (3D) weaving and presenting the shape of a rectangular parallelepiped with a large face having an area of about 8 square centimeters (cm²) and having a thickness of about 3 millimeters (mm). After the reactor had been emptied of the air it contained, methane (CH₄) was introduced as a carbon-precursor gas.

The initial pressure inside the oven was set at 5 megapascals (MPa). It rose on its own progressively up to about 9 MPa (due to an increase in the temperature and to the production of dihydrogen), such that the fluid remained in the supercritical state throughout the entire duration of infiltration (the pressure PC of the temperature T_{c} of the critical point of methane being PC=4.6 MPa and T_{c}=−83° C.). The substrate was heated, with temperature rising from ambient temperature up to the desired temperature. As soon as the temperature desired for the center of the substrate was obtained, the time for infiltration was set at 10 minutes. A temperature gradient was present within the porous substrate.

A study of the infiltration of porous substrates as a function of temperature T at the center of the substrate (900° C., 1000° C., 1100° C., and 1200° C.) was undertaken. Temperature was measured using a thermocouple.

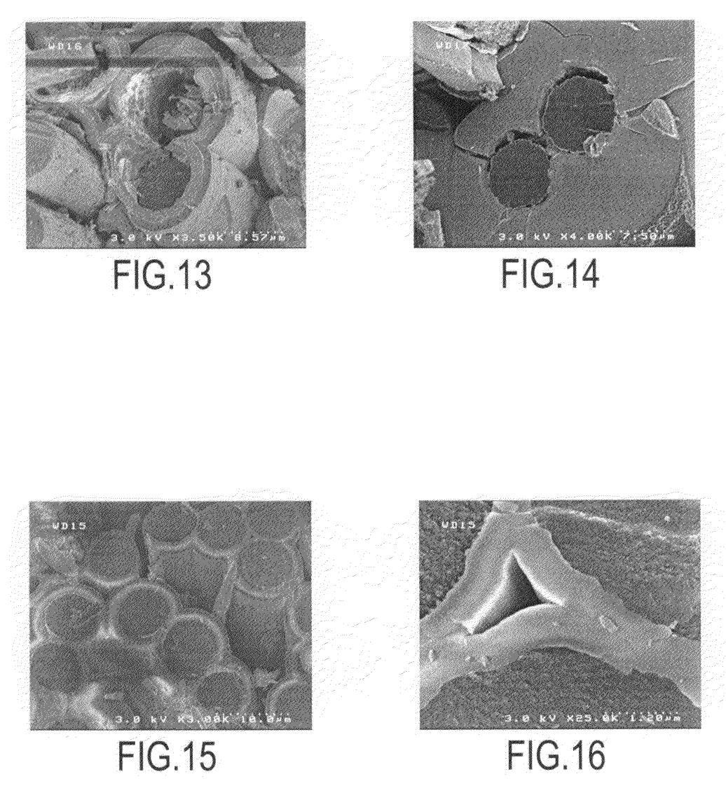

Whatever the temperature, a solid deposit was observed, covering each carbon fiber of the substrate in a sheath. Optical microscope images taken of the core of the substrate for different temperatures T of 1000° C., 1100° C., and 1200° C. (FIGS. 6, 7, and 8 respectively) show the presence of the deposit around each fiber. Optical microscopy made it possible to determine that the deposit was made up of rough laminar type carbon.

It can be seen that the densification of the substrate improved with increasing core temperature. The weight gain of the substrate after infiltration is given in Table 1. This variation in weight tends to increase with the temperature set during infiltration. The morphological images also show the presence of spongy carbon in the pores of the substrate.

TABLE 1

| | Initial | | | |
|---|---|---|---|---|
| | weight of | Weight after | Weight | Weight |
| Temperature | substrate | infiltration | gain | gain |
| (° C.) | (g) | (g) | (g) | (%) |
| 1000 | 1.04 | 1.62 | 0.58 | 55 |
| 1100 | 1.01 | 1.53 | 0.52 | 52 |
| 1200 | 1.15 | 2.19 | 1.04 | 90 |

### EXAMPLE 2

The procedure was the same as in Example 1, with the substrate being heated until the temperature T in the core of the substrate was 1000° C.

Three 10-minute cycles of infiltration were then performed at that temperature. Between two infiltration cycles, the oven was allowed to cool down to ambient temperature, the oven was then emptied, and methane was introduced at an initial pressure of 5 MPa.

Regardless of the duration of infiltration, a deposit of solid carbon was observed sheathing the carbon fibers. Optical microscope images of the core of the substrate after three infiltration cycles show the presence of that deposit of carbon around each fiber, as can be seen in FIGS. 9 and 10.

Substrate densification was improved with increasing number of infiltration cycles, as shown in Table 2, where the first row of Table 2 reproduces the data from the first row of Table 1.

TABLE 2

| | Initial | | | |
|---|---|---|---|---|
| Number of | weight of | Weight after | Weight | Weight |
| infiltration | substrate | infiltration | gain | gain |
| cycles | (g) | (g) | (g) | (%) |
| 1 | 1.04 | 1.62 | 0.58 | 55 |
| 3 | 1.16 | 2.36 | 1.20 | 103 |

### EXAMPLE 3

The procedure was the same as in Example 1, but using a composition constituted by a mixture of 6% methane and 94% di-nitrogen (by volume).

The initial total pressure in the oven was set at MPa and it rose on its own progressively up to 8 MPa such that the methane remained in the supercritical state throughout the duration of infiltration. Once the desired temperature had been reached in the center of the substrate (1000° C.), the time for infiltration was set at minutes.

A solid covering sheathing each carbon fiber and having a thickness of about 500 nanometers (nm) was observed (FIG. 11). The spongy carbon observed in FIG. 6 with 100% methane under the same conditions of infiltration was absent, as can be seen in FIG. 11. Thus, reducing the partial pressure of methane in the oven, while maintaining the same initial total pressure of 5 MPa so as to conserve the supercritical state of the methane, made it possible to produce a uniform carbon covering around each fiber.

### EXAMPLE 4

The procedure was as in Example 2, but using a laboratory reactor of the type shown in FIG. 4, enabling the substrate to be heated isothermally.

Three infiltration cycles were performed, each having a duration of 10 minutes after the 1000° C. temperature desired for the substrate had been reached. FIG. 12 shows that a solid carbon deposit was obtained surrounding each fiber. FIG. 12 also shows that when the substrate is infiltrated under isothermal conditions, spongy carbon is present in negligible quantity in the core of the substrate. Weight gain was less than Example 2, as is shown by Table 3. Nevertheless, the carbon covering around each fiber was of uniform thickness, of the order of 1 micrometer (μm).

TABLE 3

| | Initial | | | |
|---|---|---|---|---|
| | weight of | Weight after | Weight | Weight |
| Substrate | substrate | infiltration | gain | gain |
| heating | (g) | (g) | (g) | (%) |
| Temperature | 1.16 | 2.367 | 1.20 | 103 |
| gradient | | | | |
| (Example 2) | | | | |
| Isothermal | 0.45 | 0.80 | 0.35 | 78 |
| (Example 4) | | | | |

### EXAMPLE 5

A laboratory reactor of the same type as that of FIG. 1 was used having a volume capacity of 0.5 L for densifying a porous substrate with a matrix, the substrate being constituted by a braid of carbon fibers weighing 0.21 grams (g). The precursor was tetramethylsilane (TMS).

0.79 g of TMS was introduced into the reactor together with nitrogen as dilution fluid (critical point of nitrogen: PC=3.35 MPa and T_{c}=−147° C.). The pressure in the oven was initially established at 4 MPa and rose on its own progressively up to 6.8 MPa, such that the nitrogen remained in the supercritical state throughout the duration of the infiltration process. The substrate was heated with a temperature rise from ambient temperature up to a value of 560° C. as measured at the end of the infiltration process using a thermocouple placed close to the fiber substrate (about 2 mm therefrom), with the total duration of the process being 95 minutes.

It was then observed that all of the TMS had been consumed. The measured weight of the deposit (increase in weight of the substrate) was 0.52 g. FIGS. 13 and 14 are micrographs taken using a scanning electron microscope showing the solid deposit of matrix that was obtained sheathing the carbon fibers.

An analysis of the deposit using Auger electron spectrometry and X-ray diffraction showed that it was made up of silicon carbide SiC, free carbon C, and silicon nitride Si₃N₄ (shown that the nitrogen behaves as a reagent gas).

### EXAMPLE 6

The procedure was the same as in Example 5, but using a porous substrate constituted by a three-dimensional fiber preform made of carbon (obtained by 3D weaving), weighing 0.74 g.

0.54 g of TMS was introduced into the reactor together with nitrogen in the supercritical state as dilution fluid. The infiltration process was performed for a duration of 124 minutes, pressure rising from 4.1 MPa to 6.7 MPa.

The measured weight of the deposit was 0.17 g. FIGS. 15 and 16 show the solid deposit of matrix around the fibers of the preform. Analysis of the deposit showed that it was made up of SiC and of free carbon C (with carbon alone in the outer layer of the deposit).

Nitrogen did not act as a reagent fluid.

The above examples show various remarkable aspects of the supercritical chemical infiltration method of the invention:

the time required for densification is remarkably short, to be compared with durations of several tens to several hundreds of hours as required for conventional CVI processes;

the porous fiber substrate is densified to the core with each fiber being coated, which densification takes place under a pressure of several MPa, whereas in conventional CVI processes, the person skilled in the art is taught to maintain a pressure that is very low (a few kPa to a few tens of kPa) so as to avoid a deposit forming in preferred manner on the surface and obstructing access to the internal pores of the substrate, as happens if the pressure becomes too high;

a low partial pressure for the reagent gas in the supercritical medium, which encourages deposition to take place around each fiber and avoids deposition taking place in the pores of the substrate where that might impede access to the internal pores of the substrate; and

a plurality of successive infiltration operations improve substrate densification.

1. A method of densifying a refractory porous fiber substrate by forming a solid deposit of a refractory matrix within the pores of the substrate from a fluid composition diffused within the substrate and containing at least one reagent fluid that is a precursor for the material constituting the solid deposit of the matrix to be made, and optionally a dilution fluid, the method being implemented at a temperature and a pressure that enable the reagent fluid and/or the optionally-present dilution fluid to be maintained in the supercritical state, and enabling the solid deposit of the refractory matrix to form spontaneously and directly within the substrate from the precursor reagent fluid.

2. A method according to claim 1, in which the solid deposit of the matrix is formed at a temperature lying in the range 600° C. to 1500° C.

3. A method according to claim 1, in which the fluid composition contains at least one reagent fluid that is a precursor for the material constituting the solid deposit that is to be formed, together with a dilution fluid, and the method is implemented at a temperature and under a pressure that enable at least the dilution fluid to be maintained in the supercritical state.

4. A method according to claim 3, in which the dilution fluid is chemically inert relative to forming the solid deposit.

5. A method according to claim 4, in which the dilution fluid is selected from the rare gases of the atmosphere.

6. A method according to claim 3, in which the dilution fluid also constitutes a reagent fluid for forming the solid deposit.

7. A method according to claim 6, in which the dilution fluid is selected from nitrogen and carbon dioxide.

8. A method according to claim 1, in which the reagent fluid and the dilution fluid are both maintained in the supercritical state.

9. A method according to claim 1, including steps of introducing a quantity of fluid composition into an enclosure containing the substrate, and of establishing, within the enclosure, temperature and pressure conditions enabling the solid deposit to be formed, while maintaining the reagent fluid and/or the optionally-present dilution fluid in the supercritical state.

10. A method according to claim 1, comprising the steps of continuously admitting a stream of fluid composition into an enclosure containing the substrate, of continuously extracting a stream of effluent fluid from the enclosure, and of maintaining conditions of substrate temperature and of pressure within the substrate that enable the solid deposit to be formed while maintaining the reagent fluid and/or the optionally-present dilution fluid to be maintained in the supercritical state.
